(19) United States
(12) Patent Application Publication
(10) Pub. No.: US 2026/0123644 A1
(43) Pub. Date: May 7, 2026

(54) STABLE EMULSIONS AT LOW TEMPERATURE

(71) Applicant: FIRMENICH SA, Satigny (CH)

(72) Inventors: Qiu-Min MA, Shanghai (CN); Fan ZHANG, Shanghai (CN); Yi LIU, Shanghai (CN); Yan-Dong LI, Shanghai (CN)

(73) Assignee: FIRMENICH SA, Satigny (CH)

(21) Appl. No.: 19/117,426

(22) PCT Filed: Sep. 22, 2023
(86) PCT No.: PCT/EP2023/076201

§ 371 Date: Apr. 1, 2025

(30) Foreign Application Priority Data
Oct. 11, 2022 (WO) PCT/CN2022/124539
Nov. 7, 2022 (EP) 22205745.7

(51) Int. Cl. A23D 7/005; A23D 7/04

(52) U.S. Cl. CPC A23D 7/0053; A23D 7/04

(57) ABSTRACT

A lipid or enzyme-modified lipid emulsion with excellent stability at low temperatures is developed. The lipid or enzyme-modified lipid emulsion includes an aqueous phase comprising 1.0-15 wt % modified starch or a polyglycerol ester of fatty acids (PGE) and 30-50 wt % organic solvent; and an oil phase comprising 1.0-20 wt % lipid or enzyme-modified lipid, such as enzyme-modified butter flavor or enzyme-modified plant oil, and 5.0-25 wt % edible oil. The lipid or enzyme-modified lipid emulsion may further include 0.1-5.0 wt % crystallization inhibitor and/or 0-15 wt % weighting agent. The enzyme-modified butter flavor or enzyme-modified plant oil in the lipid or enzyme-modified lipid emulsion is selected from the group consisting of monoglyceride, diglyceride, triglyceride, and a mixture thereof. A method for preparing the lipid or enzyme-modified lipid emulsion is also developed.

### CROSS-REFERENCE TO RELATED APPLICATIONS

This application claims the benefit of priority of PCT International Application No. PCT/CN2022/124539, filed Oct. 11, 2022, and European Application No. 22205745.7, filed Nov. 7, 2022, which are hereby incorporated by reference as though set forth herein in their entireties.

### FIELD OF INVENTION

The present invention generally relates to the flavor industry. Specifically, the present invention relates to a lipid or enzyme-modified emulsion, such as butter or plant oil emulsion.

### BACKGROUND OF THE INVENTION

Oil-in-water emulsions have been widely used as flavor delivery systems in the food industry. Lipids or enzyme modified lipids, such as enzyme modified butter flavor or enzyme modified plant oil, are good mouthfeel enhancers. Butter or enzyme-modified butter flavors consisting of mixtures of monoglyceride, diglyceride or triglyceride are frequently used as emulsifying agents to improve the mouthfeel (e.g., creaminess or smoothness) of food products, such as bakery products, beverages, yogurt, ice cream, chewing gum, shortening, whipped toppings, margarine, spreads and peanut butter, and confections. However, the application of conventional lipids or enzyme-modified lipids, such as enzyme modified butter flavor or enzyme modified plant oil, has been significantly limited due to their low water solubility. Emulsions can be used to increase the water dispersity of lipids or enzyme-modified lipids, such as enzyme modified butter flavor or enzyme modified plant oil. In winter, lipids or enzyme-modified lipids are often stored or transported at a low temperature, e.g., in some extreme situations, the temperature could be as low as −20° C. or −30° C., which leads to the crystallization of the lipids or enzyme-modified lipids, such as enzyme-modified butter flavors. As crystallization is a big challenge to the stability of such emulsions, there is a great need in the industry to improve the stability of emulsions comprising lipids or enzyme-modified lipids, such as enzyme modified butter flavor or enzyme modified plant oil, at low temperature. The low temperature stability is mainly freeze-thaw stability, especially freeze-thaw stability at a shearing state, because the product suffers from shaking during transportation at a low temperature, e.g., in winter.

### BRIEF SUMMARY OF THE INVENTION

In one aspect of the present invention, a lipid or enzyme-modified lipid emulsion is developed. In some embodiments, the lipid or enzyme-modified lipid emulsion includes an aqueous phase comprising 1.0-15 wt % modified starch or a polyglycerol ester of fatty acids (PGE) and 30-50 wt % organic solvent; and an oil phase comprising 1.0-20 wt % lipid or enzyme-modified lipid and 5.0-25 wt % edible oil.

According to some embodiments of the present invention, the lipid is butter or plant oil.

According to some embodiments of the present invention, the enzyme-modified lipid is enzyme-modified butter flavor or enzyme-modified plant oil.

According to some embodiments of the present invention, the enzyme-modified butter flavor or enzyme-modified plant oil is selected from the group consisting of: monoglyceride, diglyceride, triglyceride, and a mixture thereof.

According to some embodiments of the present invention, the lipid or enzyme-modified lipid is present in an amount of less than 20 wt %.

According to some embodiments of the present invention, the lipid or enzyme-modified lipid is present in an amount of less than 10 wt %.

According to some embodiments of the present invention, the organic solvent is selected from the group consisting of: glycerol, propylene glycol, ethanol, butanol, sugar alcohol and a mixture thereof.

According to some embodiments of the present invention, the organic solvent is present in an amount of greater than 30 wt %.

According to some embodiments of the present invention, the organic solvent is present in an amount of greater than 40 wt %.

According to some embodiments of the present invention, the edible oil is selected from the group consisting of: flavor oil, plant oil, medium-chain fatty acids, medium-chain triglycerides, limonene, glycerin triacetate, ethyl citrate, benzyl benzoate, ethyl laurate, ethyl myristate, and a mixture thereof.

According to some embodiments of the present invention, the plant oil is selected from the group consisting of: sunflower oil, coconut oil, soya oil, castor oil, canola oil, peanut oil, sesame oil, olive oil, rapeseed oil, and a mixture thereof. As used herein, medium-chain triglycerides are esters of glycerol and medium-chain fatty acids. According to some embodiments of the present invention, the medium-chain triglycerides comprise caprylic and/or capric triglycerides, such as Neobee oil.

According to some embodiments of the present invention, the lipid or enzyme-modified lipid emulsion further includes 0.1-5.0 wt % crystallization inhibitor and/or 0-15 wt % weighting agent.

According to some embodiments of the present invention, the crystallization inhibitor is selected from the group consisting of: polyglyceryl fatty acid ester, sucrose fatty acid ester, and a mixture thereof.

According to some embodiments of the present invention, the weighting agent is selected from the group consisting of: glycerol ester of wood rosin (E445), sucrose acetate isobutyrate, dammar resin, and a mixture thereof.

According to some embodiments of the present invention, the lipid or enzyme-modified lipid emulsion further includes 0.01-2.0 wt % vitamin E and/or 0.01-2.0 wt % vitamin C.

According to some embodiments of the present invention, the lipid or enzyme-modified lipid emulsion further includes 0.01-2.0 wt % preservative.

In another aspect of the present invention, a method for preparing the lipid or enzyme-modified lipid emulsion as discussed in the one aspect of the present invention is developed. In some embodiments, the method includes: mixing the modified starch or a polyglycerol ester of fatty acids (PGE) with water at a first predetermined temperature to form the aqueous phase; melting the lipid or enzyme-modified lipid, such as enzyme-modified butter flavor or enzyme-modified plant oil, at a second predetermined temperature and mixing the lipid or enzyme-modified lipid, such as enzyme-modified butter flavor or enzyme-modified plant oil, with the edible oil at a third predetermined temperature to form the oil phase; mixing the aqueous phase and the oil phase on a magnetic stirring plate to form the lipid or enzyme-modified lipid emulsion; pre-emulsifying the lipid or enzyme-modified lipid emulsion using a high-speed homogenizer for a first period of time; and homogenizing the resulted pre-emulsion at a predetermined pressure for predetermined times using a 2-stage high-pressure homogenizer.

According to some embodiments of the present invention, the first predetermined temperature comprises 35° C. to 75° C., preferably 50° C. to 70° C., more preferably 65° C.

According to some embodiments of the present invention, the second predetermined temperature comprises 35° C. to 75° C., preferably 50° C. to 70° C., more preferably 65° C.

According to some embodiments of the present invention, the third predetermined temperature comprises 35° C. to 75° C., preferably 50° C. to 70° C., more preferably 65° C.

According to some embodiments of the present invention, the lipid is butter or plant oil.

According to some embodiments of the present invention, the enzyme-modified lipid is enzyme-modified butter flavor or enzyme-modified plant oil.

According to some embodiments of the present invention, the enzyme-modified butter flavor or enzyme-modified plant oil is selected from the group consisting of: monoglyceride, diglyceride, triglyceride, and a mixture thereof.

According to some embodiments of the present invention, the lipid or enzyme-modified lipid is present in an amount of less than 20 wt %.

According to some embodiments of the present invention, the lipid or enzyme-modified lipid is present in an amount of less than 10 wt %.

According to some embodiments of the present invention, the organic solvent is selected from the group consisting of: glycerol, propylene glycol, ethanol, butanol, sugar alcohol and a mixture thereof.

According to some embodiments of the present invention, the sugar alcohol is selected from the group consisting of: arabitol, erythritol, xylitol, lactitol, maltitol, mannitol, sorbitol, isomalt and a mixture thereof.

According to some embodiments of the present invention, organic solvent is present in an amount of greater than 30 wt %.

According to some embodiments of the present invention, the organic solvent is present in an amount of greater than 40 wt %.

According to some embodiments of the present invention, the edible oil is selected from the group consisting of: flavor oil, plant oil, medium-chain fatty acids, medium-chain triglycerides, limonene, glycerin triacetate, ethyl citrate, benzyl benzoate, ethyl laurate, ethyl myristate, and a mixture thereof.

According to some embodiments of the present invention, the plant oil is selected from the group consisting of: sunflower oil, coconut oil, soya oil, castor oil, canola oil, peanut oil, sesame oil, olive oil, rapeseed oil, and a mixture thereof.

Numerous benefits are achieved by way of the present invention over conventional techniques. For example, some embodiments of the present invention provide a lipid or enzyme-modified lipid emulsion including a large amount of organic solvent and a relatively small amount of lipid or enzyme-modified lipid. The lipid or enzyme-modified lipid emulsion according to some embodiments of the present invention has excellent stability at low temperatures. It may facilitate the transportation and storage of the lipid or enzyme-modified lipid emulsion at low temperature without concern that the lipid or enzyme-modified lipid emulsion will lose stability due to crystallization of the lipid or enzyme-modified lipid. These and other embodiments of the present invention along with many of its advantages and features are described in more detail in conjunction with the text below.

### DETAILED DESCRIPTION OF THE INVENTION

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All dosage ranges contained within this application are intended to include all numbers, whole or fractions, contained within said range. All percentages expressed herein are by weight of the total weight of the beverage composition unless expressed otherwise. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a milk”, “a method”, or “a food” includes a plurality of such “milks”, “methods”, or “foods”. Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive. As used herein, “about” is understood to refer to numbers in a range of numerals.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

As used herein, “wt %” means percentage by weight as understood by a person of ordinary skill in the art. Unless otherwise indicated, the percentage by weight is relative to the total weight of the lipid or enzyme-modified lipid emulsion.

In one aspect of the present invention, a lipid or enzyme-modified lipid emulsion is developed by incorporating high content of food grade solvent and controlling the butter content in the oil phase. In some embodiments, the lipid or enzyme-modified lipid emulsion may include an aqueous phase and an oil phase. In some embodiments, the aqueous phase may include modified starch or polyglycerol ester of fatty acids (PGE), organic solvent, and water. For example, the organic solvent may be selected from the group consisting of glycerol, propylene glycol, ethanol, butanol, sugar alcohol, and a mixture thereof.

A modified starch is a food starch that has been chemically modified by known methods to have a chemical structure which provides it with a hydrophilic and a lipophilic portion. Preferably the modified starch has a long hydrocarbon chain as part of its structure (preferably C5-C18). A preferred modified starch is “OSA-starch” (starch sodium octenyl succinate). Here, the term “OSA-starch” denotes any starch (from any natural source such as corn, waxy maize, waxy corn, wheat, tapioca and potato or synthesized) that was treated with octenyl succinic anhydride (OSA). The term “OSA-starches” encompasses also such starches that are commercially available, e.g., from National Starch under the tradenames HiCap 100, Capsul (octenylbutanedioate amylodextrin), Capsul HS, Purity Gum 2000, Purity Gum®Ultra, Clear Gum Co03, UNI-PURE, HYLON VII; from National Starch and Roquette Freres, respectively; from 30 CereStar under the tradename CssEmCap or from Tate & Lyle. Preferred is Purity Gum 2000 and Purity Gum®Ultra. In some embodiments, the modified starch may be present in an amount of from about 1.0 wt % to about 15 wt % of the lipid or enzyme-modified lipid emulsion. Preferably, the modified starch may be present in an amount of from about 3.0 wt % to about 10 wt % of the lipid or enzyme-modified lipid emulsion. More preferably, the modified starch may be present in an amount of from about 5.0 wt % to about 8.0 wt % of the lipid or enzyme-modified lipid emulsion. In some embodiments, the organic solvent may be present in an amount of from about 30 wt % to about 50 wt % of the lipid or enzyme-modified lipid emulsion. Preferably, the organic solvent may be present in an amount of from about 33 wt % to about 45 wt % of the lipid or enzyme-modified lipid emulsion. More preferably, the organic solvent may be present in an amount of from about 35 wt % to about 42 wt % of the lipid or enzyme-modified lipid emulsion. In one preferable embodiment, the aqueous phase may include 5.0 wt % modified starch and 40 wt % glycerol. In another preferable embodiment, the aqueous phase may include 7.0 wt % modified starch, and 40 wt % glycerol. In another preferable embodiment, the aqueous phase may include 8.0 wt % modified starch, and 40 wt % glycerol. In another preferable embodiment, the aqueous phase may include 5.0 wt % modified starch, and 50 wt % glycerol.

Polyglycerol ester of fatty acids (PGE) are esters formed from the esterification of polymers of glycerol with saturated and/or unsaturated fatty acids. The degree of polymerization of the polyglycerol ester of fatty acids is not particularly limited. However, in an embodiment, the polyglycerol ester of fatty acids has a degree of polymerization of from 2 to 10 glycerol units, typically 2, 4, 6, or 10 glycerol units.

The fatty acids in the polyglycerol ester are saturated and/or unsaturated fatty acids. The number of carbons in the fatty acids are not particularly limited. However, in an embodiment, the number of carbons in the fatty acids is from 12 to 18, typically 12 to 14. In an embodiment, the fatty acids in the polyglycerol ester are saturated fatty acids. Suitable saturated fatty acids include, but are not limited to, lauric acid, myristic acid, palmitic acid, stearic acid, and any mixture thereof. In another embodiment, the fatty acids in the polyglycerol ester are unsaturated fatty acids. Suitable unsaturated fatty acids include, but are not limited to, oleic acid, linoleic acid, linolenic acid, and any mixture thereof. In an embodiment, the polyglycerol ester of fatty acids (PGE) is a myristic acid ester of polyglycerol, typically decaglycerol mono-myristate (available as SY-Glyster MM-750; Sakamoto Yakuhin kogyo Co., Ltd.).

In some embodiments, the polyglycerol ester of fatty acids (PGE) may be present in an amount of from about 1.0 wt % to about 15 wt % of the lipid or enzyme-modified lipid emulsion. Typically, the polyglycerol ester of fatty acids (PGE) may be present in an amount of from about 3.0 wt % to about 10 wt % of the lipid or enzyme-modified lipid emulsion. More typically, the polyglycerol ester of fatty acids (PGE) may be present in an amount of from about 5.0 wt % to about 8.0 wt % of the lipid or enzyme-modified lipid emulsion.

In an embodiment, the aqueous phase may include 5.0 wt % polyglycerol ester of fatty acids (PGE) and 40 wt % glycerol. In another embodiment, the aqueous phase may include 6.0 wt % polyglycerol ester of fatty acids (PGE) and 40 wt % glycerol. In yet another embodiment, the aqueous phase may include 7.0 wt % polyglycerol ester of fatty acids (PGE) and 40 wt % glycerol. In another preferable embodiment, the aqueous phase may include 8.0 wt % polyglycerol ester of fatty acids (PGE) and 40 wt % glycerol.

In some embodiments, the oil phase may include enzyme-modified butter flavor or enzyme-modified plant oil selected from the group consisting of monoglyceride, diglyceride, triglyceride, and a mixture thereof. In some embodiments, the lipid or enzyme-modified lipid may be present in an amount of less than 30 wt % of the lipid or enzyme-modified lipid emulsion, preferably less than 20 wt % of the lipid or enzyme-modified lipid emulsion. For example, the lipid or enzyme-modified lipid may be present in an amount of about 1.0 wt % to about 30 wt % of the lipid or enzyme-modified lipid emulsion. Preferably, the lipid or enzyme-modified lipid may be present in an amount of about 1.0 wt % to about 25 wt % of the lipid or enzyme-modified lipid emulsion. Preferably, the lipid or enzyme-modified lipid may be present in an amount of about 1.0 wt % to about 10 wt % of the lipid or enzyme-modified lipid emulsion. In one preferable embodiment, the lipid or enzyme-modified lipid may be present in an amount of about 1.0 wt % to about 5.0 wt % of the lipid or enzyme-modified lipid emulsion.

According some embodiments of the present invention, the oil phase may further include edible oil, such as flavor oil, plant oil, medium-chain fatty acids, medium-chain triglycerides, limonene, glycerin triacetate, ethyl citrate, benzyl benzoate, ethyl laurate, ethyl myristate, and a mixture thereof. In some embodiments, the edible oil may be present in an amount of from about 5.0 wt % to about 25 wt % of the lipid or enzyme-modified lipid emulsion. Preferably, the edible oil may be present in an amount of from about 5.0 wt % to about 20 wt % of the lipid or enzyme-modified lipid emulsion. Preferably, the edible oil may be present in an amount of from about 5.0 wt % to about 20 wt % of the lipid or enzyme-modified lipid emulsion. More preferably, the edible oil may be present in an amount of from about 6.0 wt % to about 16 wt % of the lipid or enzyme-modified lipid emulsion. In one preferable embodiment, the edible oil may be present in an amount of about 16 wt % of the lipid or enzyme-modified lipid emulsion. In one preferable embodiment, the edible oil may be present in an amount of about 9.0 wt % of the lipid or enzyme-modified lipid emulsion. In one preferable embodiment, the edible oil may be present in an amount of about 8.0 wt % of the lipid or enzyme-modified lipid emulsion. In one preferable embodiment, the edible oil may be present in an amount of about 6.0 wt % of the lipid or enzyme-modified lipid emulsion.

By “flavor oil”, it is meant here a flavouring ingredient or a mixture of flavouring ingredients, solvent or adjuvants of current use for the preparation of a flavouring formulation, i.e. a particular mixture of ingredients which is intended to be added to a composition to impart, improve or modify its organoleptic properties, in particular its flavour and/or taste. Taste modulator as also encompassed in said definition. Flavouring ingredients are well known to a skilled person in the art and their nature does not warrant a detailed description here, which in any case would not be exhaustive, the skilled flavourist being able to select them on the basis of his general knowledge and according to the intended use or application and the organoleptic effect it is desired to achieve. Many of these flavouring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, can Nostrand Co., Inc. Solvents and adjuvants or current use for the preparation of a flavouring formulation are also well known in the art.

In some embodiments, the lipid or enzyme-modified lipid emulsion may further include crystallization inhibitor, such as polyglyceryl fatty acid ester, sucrose fatty acid ester, and a mixture thereof. In some embodiments, the crystallization inhibitor may be added into the oil phase. In some embodiments, the crystallization inhibitor may be present in an amount of from about 0.05 wt % to about 10 wt % of the lipid or enzyme-modified lipid emulsion. Preferably, the crystallization inhibitor may be present in an amount of from about 0.1 wt % to about 5.0 wt % of the lipid or enzyme-modified lipid emulsion.

In some embodiments, the lipid or enzyme-modified lipid emulsion may further include weighting agents, such as glycerol ester of wood rosin (E445), sucrose acetate isobutyrate, dammar resin, and a mixture thereof. In some embodiments, the weighting agents may be added into the oil phase of the lipid or enzyme-modified lipid emulsion. In some embodiments, the weighting agents may be present in an amount of from about 0 wt % to about 15 wt % of the lipid or enzyme-modified lipid emulsion. Preferably, the weighting agent may be present in an amount of from about 0 wt % to about 10 wt % of the lipid or enzyme-modified lipid emulsion.

In some embodiments, the lipid or enzyme-modified lipid emulsion may further include additional ingredients, such as sugar, antioxidant, preservatives, and other hydrophobic ingredients. For example, the sugar may include sucrose, glucose, fructose, galactose, lactose, maltose, syrup, and a mixture thereof. For example, the antioxidant may include vitamin C, vitamin E, and a mixture thereof. In some embodiments, the antioxidant may be present in an amount of from about 0.01 wt % to about 2.0 wt % of the lipid or enzyme-modified lipid emulsion. For example, the other hydrophobic ingredients may include, but not be limited to, oil-soluble pharmaceutical ingredients, oil-soluble nutraceutical ingredients (e.g., oil-soluble vitamins), oil-soluble colorants, oil-soluble antimicrobial ingredients, oil-soluble defoamers, mouthfeel modulators, taste modulators. As used herein, preservatives include any suitable preservatives approved for use in beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and combinations thereof. Preservatives may be used in amounts not exceeding mandated maximum levels under applicable laws and regulations. In some embodiments, the preservative may be present in an amount of from about 0.01 wt % to about 2.0 wt % of the lipid or enzyme-modified lipid emulsion.

In some embodiments, the lipid or enzyme-modified lipid emulsion may further include a thickening agent, typically a thickening agent suitable for food applications. Exemplary thickening agents include, but are not limited to, guar gum, pectin, xanthan gum, alginates, gelatin, starches (including corn, potato, rice or tapioca), maltodextrin, wheat gluten, carboxymethylcellulose, carrageenan, konjac, locust bean gum, and the like.

In another aspect of the present invention, a method for preparing a lipid or enzyme-modified lipid emulsion as discussed above is developed. In some embodiments, the method may include mixing modified starch or polyglycerol ester of fatty acids (PGE) with water to form the aqueous phase. It should be noted that the aqueous phase may further include other water soluble ingredients discussed above. For example, other water soluble ingredients may include, but not limited to, sugar, salt, water soluble vitamins, and preservatives. In some embodiments, the mixing process is performed at a first predetermined temperature. For example, the first predetermined temperature may include from about 35° C. to about 75° C., preferably from about 50° C. to about 70° C., more preferably about 65° C.

Next, the method may include melting the lipid or enzyme-modified lipid, such as enzyme-modified butter flavor or enzyme-modified plant oil, at a second predetermined temperature and mixing the lipid or enzyme-modified lipid, such as enzyme-modified butter flavor or enzyme-modified plant oil, with edible oil to form the oil phase. As discussed above, the lipid or enzyme-modified lipid, typically enzyme-modified butter flavor or enzyme-modified plant oil, may be selected from the group consisting of monoglyceride, diglyceride, triglyceride, and a mixture thereof. In some embodiments, the lipid or enzyme-modified lipid may be present in an amount of less than 30 wt % of the lipid or enzyme-modified lipid emulsion, preferably less than 20 wt % of the lipid or enzyme-modified lipid emulsion. In some embodiments, the edible oil may be selected from the group consisting of: flavor oil, plant oil, medium-chain fatty acids, medium-chain triglycerides, limonene, glycerin triacetate, ethyl citrate, benzyl benzoate, ethyl laurate, ethyl myristate, and a mixture thereof. The amount of the edible oil may be referred to in the above discussion. It should be noted that the oil phase may further include other oil soluble ingredients discussed above. In some embodiments, the oil soluble ingredients may include the crystallization inhibitors, weighting agents, as discussed above. In some embodiments, the second predetermined temperature may include from about 35° C. to about 75° C., preferably from about 50° C. to about 70° C., more preferably about 65° C. In some embodiments, the mixing process to form the oil phase may be performed at a third predetermined temperature. For example, the third predetermined temperature may include from about 35° C. to about 75° C., preferably from about 50° C. to about 70° C., more preferably about 65° C.

Then the method includes mixing the aqueous phase and the oil phase on a magnetic stirring plate to form the lipid or enzyme-modified lipid emulsion. Next, the method may further include pre-emulsifying the lipid or enzyme-modified lipid emulsion using a high-speed homogenizer a 10,000 rpm for a first period of time. The high-speed homogenizer as used herein may be a T25 Digital Ultra Turrax® (IKA®, Germany). Then the method may further include homogenizing the resulted pre-emulsion at a predetermined pressure for predetermined times using a 2-stage high-pressure homogenizer. For example, the 2-stage high-pressure homogenizer may be a APV-1000 lab homogenizer (SPXFLOW®, US). In some embodiments, the predetermined pressure may be 160/40 bar. In some embodiments, the predetermined pressure may be 250/50 bar, preferably 300/50 bar, more preferably 350/50 bar. In some embodiments, the predetermined times may be 2 or 3 times. In some embodiments, homogenization may be performed for 4 times, 5 times, or more times as appropriate as the particular application requires.

Embodiments according to some aspects of the present disclosure
1. A butter emulsion, comprising:
   an aqueous phase comprising 1.0-15 wt % modified starch and 30-50 wt % organic solvent; and
   an oil phase comprising 1.0-20 wt % enzyme-modified butter flavor and 5.0-25 wt % edible oil.
2. The butter emulsion of embodiment 1, wherein the enzyme-modified butter flavor is selected from the group consisting of monoglyceride, diglyceride, triglyceride, and a mixture thereof.
3. The butter emulsion of embodiment 1 or 2, wherein the enzyme-modified butter flavor is present in an amount of less than 20 wt %.
4. The butter emulsion of any one of embodiments 1 to 3, wherein the enzyme-modified butter flavor is present in an amount of less than 10 wt %.
5. The butter emulsion of any one of embodiments 1 to 4, wherein the organic solvent is selected from the group consisting of: glycerol, propylene glycol, ethanol, butanol, sugar alcohol and a mixture thereof.
6. The butter emulsion of any one of embodiments 1 to 5, wherein the organic solvent is present in an amount of greater than 30 wt %.
7. The butter emulsion of any one of embodiments 1 to 6, wherein the organic solvent is present in an amount of greater than 40 wt %.
8. The butter emulsion of any one of embodiments 1 to 7, wherein the edible oil is selected from the group consisting of flavor oil, plant oil, medium-chain fatty acids, limonene, glycerin triacetate, ethyl citrate, benzyl benzoate, ethyl laurate, ethyl myristate, and a mixture thereof.
9. The butter emulsion of any of embodiment 1 to 8, further comprising 0.1-5.0 wt % crystallization inhibitor and/or 0-15 wt % weighting agent.
10. The butter emulsion of embodiment 9, wherein the crystallization inhibitor is selected from the group consisting of: polyglycerol fatty acid ester, sucrose fatty acid ester, and a mixture thereof.
11. The butter emulsion of embodiment 9 or 10, wherein the weighting agent is selected from the group consisting of: glycerin rosin ester, sucrose acetate isobutyrate, dammar resin, and a mixture thereof.
12. The butter emulsion of any of embodiments 1 to 11, further comprising: 0.01-2 wt % vitamin E and/or 0.01-2.0 wt % vitamin C.
13. The butter emulsion of any of embodiments 1 to 12, further comprising: 0.01-2 wt % preservative.
14. A method for preparing a butter emulsion of embodiment 1, comprising:
   mixing the modified starch with water at a first predetermined temperature to form the aqueous phase;
   melting the enzyme-modified butter flavor at a second predetermined temperature and mixing the enzyme-modified butter flavor with the edible oil at a third predetermined temperature to form the oil phase;
   mixing the aqueous phase and the oil phase on a magnetic stirring plate to form the butter emulsion;
   pre-emulsifying the butter emulsion using a high-speed homogenizer for a first period of time; and
   homogenizing the resulted pre-emulsion at a predetermined pressure for predetermined times using a 2-stage high-pressure homogenizer.
15. The method of embodiment 14, wherein the first predetermined temperature comprises 35° C. to 75° C., preferably 50° C. to 70° C., more preferably 65° C.
16. The method of embodiment 14 or 15, wherein the second predetermined temperature comprises 35° C. to 75° C., preferably 50° C. to 70° C., more preferably 65° C.
17. The method of any one of embodiments 14 to 16, wherein the third predetermined temperature comprises 35° C. to 75° C., preferably 50° C. to 70° C., more preferably 65° C.
18. The method of any one of embodiments 14 to 17, wherein the enzyme-modified butter flavor is selected from the group consisting of: monoglyceride, diglyceride, triglyceride, and a mixture thereof.
19. The method of any one of embodiments 14 to 18, wherein the enzyme-modified butter flavor is present in an amount of less than 20 wt %.
20. The method of any one of embodiments 14 to 19, wherein the enzyme-modified butter flavor is present in an amount of less than 10 wt %.
21. The method of any one of embodiments 14 to 20, wherein the organic solvent is selected from the group consisting of: glycerol, propylene glycol, ethanol, butanol, sugar alcohol and a mixture thereof.
22. The method of any one of embodiments 14 to 21, wherein the organic solvent is present in an amount of greater than 30 wt %.
23. The method of any one of embodiments 14 to 22, wherein the organic solvent is present in an amount of greater than 40 wt %.
24. The method of any one of embodiments 14 to 23, wherein the edible oil is selected from the group consisting of: flavor oil, plant oil, medium-chain fatty acids, limonene, glycerin triacetate, ethyl citrate, benzyl benzoate, ethyl laurate, ethyl myristate, and a mixture thereof.

### EXAMPLES

The present invention is illustrated further herein by the following non-limiting examples.

### Example A

In Example A, a butter emulsion includes 4.0 wt % enzyme-modified butter flavor, 16 wt % sunflower oil, 5.0 wt % modified starch, 40 wt % glycerol, and water quantity sufficient to 100 wt %. The ingredients and their respective percentage by weight in Example A are shown in below Table 1.

TABLE 1

| | wt % of final |
|---|---|
| Ingredient | butter emulsion |
| Enzyme-modified | 4.0 |
| butter flavor | |
| Sunflower Oil | 16.0 |
| Modified Starch | 5.0 |
| Glycerol | 40.0 |
| Water | 35.0 |

### Example B

In Example B, a butter emulsion includes 4.0 wt % enzyme-modified butter flavor, 16 wt % sunflower oil, 8.0 wt % modified starch, 40 wt % glycerol, and water quantity sufficient to 100 wt %. The ingredients and their respective percentage by weight in Example B are shown in below Table 2.

TABLE 2

| | wt % of final |
|---|---|
| Ingredient | butter emulsion |
| Enzyme-modified | 4.0 |
| butter flavor | |
| Sunflower Oil | 16.0 |
| Modified Starch | 8.0 |
| Glycerol | 40.0 |
| Water | 32.0 |

### Example C

In Example C, a butter emulsion includes 4.0 wt % enzyme-modified butter flavor, 16 wt % sunflower oil, 5.0 wt % modified starch, 50 wt % glycerol, and water quantity sufficient to 100 wt %. The ingredients and their respective percentage by weight in Example C are shown in below Table 3.

TABLE 3

| | wt % of final |
|---|---|
| Ingredient | butter emulsion |
| Enzyme-modified | 4.0 |
| butter flavor | |
| Sunflower Oil | 16.0 |
| Modified Starch | 5.0 |
| Glycerol | 50.0 |
| Water | 25.0 |

### Example D

In Example D, a butter emulsion includes 4.0 wt % enzyme-modified butter flavor, 16 wt % rapeseed oil, 5.0 wt % modified starch, 40 wt % glycerol, and water quantity sufficient to 100 wt %. The ingredients and their respective percentage by weight in Example D are shown in below Table 4.

TABLE 4

| | wt % of final |
|---|---|
| Ingredient | butter emulsion |
| Enzyme-modified | 4.0 |
| Butter Flavor | |
| Rapeseed Oil | 16.0 |
| Modified Starch | 5.0 |
| Glycerol | 40.0 |
| Water | 35.0 |

### Example E

In Example E, a butter emulsion includes 4.0 wt % enzyme-modified butter flavor, 16 wt % rapeseed oil, 7.0 wt % modified starch, 40 wt % glycerol, and water quantity sufficient to 100 wt %. The ingredients and their respective percentage by weight in Example E are shown in below Table 5.

TABLE 5

| | wt % of final |
|---|---|
| Ingredient | butter emulsion |
| Enzyme-modified | 4.0 |
| butter flavor | |
| Rapeseed Oil | 16.0 |
| Modified Starch | 7.0 |
| Glycerol | 40.0 |
| Water | 33.0 |

### Example F

In Example F, a butter emulsion includes 4.0 wt % enzyme-modified butter flavor, 16 wt % Neobee oil, 5.0 wt % modified starch, 40 wt % glycerol, and water quantity sufficient to 100 wt %. The ingredients and their respective percentage by weight in Example F are shown in below Table 6.

TABLE 6

| | wt % of final |
|---|---|
| Ingredient | butter emulsion |
| Enzyme-modified | 4.0 |
| Butter Flavor | |
| Neobee Oil | 16.0 |
| Modified Starch | 5.0 |
| Glycerol | 40.0 |
| Water | 35.0 |

### Example G

In Example G, a butter emulsion includes 4 wt % enzyme-modified butter flavor, 16 wt % Neobee oil, 7 wt % modified starch, 40 wt % glycerol, and water quantity sufficient to 100 wt %. The ingredients and their respective percentage by weight in Example G are shown in below Table 7.

TABLE 7

| | wt % of final |
|---|---|
| Ingredient | butter emulsion |
| Enzyme-modified | 4.0 |
| butter flavor | |
| Neobee Oil | 16.0 |
| Modified Starch | 7.0 |
| Glycerol | 40.0 |
| Water | 33.0 |

### Freeze-Thaw Stability Test

Freeze-thaw stability test has been performed over each example to test the butter emulsions. Each butter emulsion in Examples A-G has been incubated in a refrigerator at a temperature of −20° C. or −30° C. for 24 hours. Subsequently, each emulsion has been thawed at room temperature (e.g., 25° C.). The freeze-thaw stability test is performed using a LumiSizer® Dispersion Analyser (LUM GmbH, Germany) with a centrifugation speed of 2,000 rpm at room temperature (e.g., 25° C.). In the freeze-thaw stability test, the light wavelength is 870 nm. A total of 800 profiles with an interval of 40 s have been collected. The instability indexes of respective examples calculated based on the change of transmission during centrifugation have been determined. A lower instability index shows that the example has higher stability. Additionally, the inventors have measured the droplet size of each butter emulsion with a Mastersizer 3000 Particle Size Analyzer (Malvern Panalytical Ltd, UK). As a comparison, the stability and droplet size of each emulsion without the above free-thaw treatment has been recorded at room temperature 25° C. The result of the freeze-thaw stability test and the droplet size have been recorded in the below Tables 8-10, wherein Table 8 shows the droplet size D (μm) of each butter emulsion discussed above in Examples A-G with and without the freeze-thaw treatment, Table 9 shows the appearance of each butter emulsion discussed above in Examples A-G at room temperature 25° C., −20° C., and −30° C., and Table 10 shows the instability index of each butter emulsion discussed in Examples A-G at room temperature 25° C., −20° C., and −30° C.

TABLE 8

| | Droplet Size | Droplet Size | Droplet Size |
|---|---|---|---|
| | of Sample | of Sample Frozen | of Sample Frozen |
| | without Freeze- | at −20° C. then | at −30° C. then |
| Sample | thaw Treatment | Thawed at 25° C. | Thawed at 25° C. |
| Example A | 0.318 | 0.349 | 0.353 |
| Example B | 0.303 | 0.353 | 0.376 |
| Example C | 0.456 | 0.531 | 0.463 |
| Example D | 0.330 | 0.274 | 0.247 |
| Example E | 0.383 | 0.338 | 0.337 |
| Example F | 0.395 | 0.323 | 0.307 |
| Example G | 0.373 | 0.302 | 0.306 |

As shown in Table 8, the butter emulsions as defined in Examples A-C exhibit that droplet size has been increased after the freeze-thaw treatment compared to the respective butter emulsions without the freeze-thaw treatment. However, the increase in the droplet size is not significant. As shown in Table 8, the butter emulsions as defined in Examples D-G exhibit that droplet size has been decreased after the freeze-thaw treatment compared to the respective butter emulsion without the freeze-thaw treatment. Therefore, the butter emulsions of the present invention are stable after freeze-thaw treatments.

TABLE 9

| | At | At | At |
|---|---|---|---|
| Sample | 25° C. | −20° C. | −30° C. |
| Example A | Flowable | Flowable | Frozen |
| Example B | Flowable | Flowable | Frozen |
| Example C | Flowable | Flowable | Flowable |
| Example D | Flowable | Flowable | Frozen |
| Example E | Flowable | Flowable | Frozen |
| Example F | Flowable | Flowable | Frozen |
| Example G | Flowable | Flowable | Frozen |

As shown in Table 9, each butter emulsion as defined in Examples A-G remains flowable at the temperature of −20° C. The butter emulsion as defined in Example C even remains flowable at the temperature of −30° C. It shows that the butter emulsion of the present invention has good stability at low temperatures.

TABLE 10

| | Instability Index | Instability Index | Instability Index |
|---|---|---|---|
| | of Sample without | of Sample Frozen | of Sample Frozen |
| | Freeze-thaw | at −20° C. then | at −30° C. then |
| Sample | Treatment | Thawed at 25° C. | Thawed at 25° C. |
| Example A | 0.009 | 0.008 | 0.007 |
| Example B | 0.003 | 0.002 | 0.004 |
| Example C | 0.03 | 0.03 | 0.027 |
| Example D | 0.007 | 0.005 | 0.005 |
| Example E | 0.005 | 0.006 | 0.005 |
| Example F | 0.011 | 0.005 | 0.007 |
| Example G | 0.006 | 0.004 | 0.006 |

As shown in Table 10, the stability of each butter emulsion as defined in Examples A-G exhibits very minor changes after the freeze-thaw treatment compared with that of the respective butter emulsion without the freeze-thaw treatment.

### Storage Stability of the Butter Emulsion

The butter emulsion as defined in Example A has been selected to test the long-term stability at low temperatures. The butter emulsion of Example A has been stored at −20° C. for one month (30 days). Then, the droplet size and instability index of the butter emulsion of Example A were tested using the same instrument and the same testing conditions. As a comparison, the droplet size and instability index of freshly formed butter emulsion of Example A is tested. The result of the test is recorded in below Table 11.

TABLE 11

| | Droplet | Instability | |
|---|---|---|---|
| Example A | Size (μm) | Index | Appearance |
| Fresh Sample | 0.375 | 0.01 | Flowable |
| Storage at −20° C. | 0.443 | 0.007 | Flowable |
| for one month | | | |

As shown in Table 11, the butter emulsion exhibits a minor increase in droplet size and a minor decrease in stability after storage at −20° C. for one month. However, the butter emulsion remains flowable. It shows that the butter emulsion according to some embodiments of the present invention could increase the stability of butter emulsion at low temperatures.

### Examples H-J

In Examples H-J, a butter emulsion includes 2.0 wt % or 3.0 wt % enzyme-modified butter flavor is formulated. The ingredients and their respective percentage by weight in Examples H-J are shown in below Table 12.

TABLE 12

| | Example H | Example I | Example J |
|---|---|---|---|
| | wt % of final | wt % of final | wt % of final |
| Ingredient | butter emulsion | butter emulsion | butter emulsion |
| Enzyme-modified | 2.0 | 2.0 | 3.0 |
| butter flavor | | | |
| Rapeseed Oil | 8.0 | 6.0 | 9.0 |
| Glycerol Ester of | / | 2.0 | 3.0 |
| Wood Rosin | | | |
| Vitamin E | 0.02 | 0.02 | 0.02 |
| Modified Starch | 7.0 | 7.0 | 7.0 |
| Glycerol | 40.0 | 40.0 | 40.0 |
| Water | 42.98 | 42.98 | 37.98 |

### Example K

A butter emulsion includes 4.0 wt % enzyme-modified butter flavor, 16 wt % sunflower oil, 5.0 wt % Purity Gum Ultra (modified starch), 40 wt % glycerol, and water quantity sufficient to 100 wt %. The ingredients and their respective percentage by weight in Example K are shown in below Table 13.

TABLE 13

| | wt % of final |
|---|---|
| Ingredient | butter emulsion |
| Enzyme-modified | 4.0 |
| butter flavor | |
| Sunflower Oil | 16.0 |
| Vitamin E | 0.02 |
| Purity Gum Ultra | 5.0 |
| Glycerol | 40.0 |
| Water | Q.S. |

### Example L

A butter emulsion includes 4.0 wt % enzyme-modified butter flavor, 16 wt % sunflower oil, 6.0 wt % SY-Glyster MM-750 (polyglycerol esters of fatty acids), 40 wt % glycerol, and water quantity sufficient to 100 wt %. The ingredients and their respective percentage by weight in Example L are shown in below Table 14.

TABLE 14

| | wt % of final |
|---|---|
| Ingredient | butter emulsion |
| Enzyme-modified | 4.0 |
| butter flavor | |
| Sunflower Oil | 16.0 |
| Vitamin E | 0.02 |
| SY-Glyster MM-750 | 6.0 |
| Glycerol | 40.0 |
| Water | Q.S. |

### Example M

A butter emulsion includes 4.0 wt % enzyme-modified butter flavor, 16 wt % Neobee oil, 6.0 wt % SY-Glyster MM-750 (polyglycerol esters of fatty acids), 40 wt % glycerol, and water quantity sufficient to 100 wt %. The ingredients and their respective percentage by weight in Example M are shown in below Table 15.

TABLE 15

| | wt % of final |
|---|---|
| Ingredient | butter emulsion |
| Enzyme-modified | 4.0 |
| butter flavor | |
| Neobee Oil | 16.0 |
| Vitamin E | 0.02 |
| SY-Glyster MM-750 | 6.0 |
| Glycerol | 40.0 |
| Water | Q.S. |

### Freeze-Thaw Stability Test

The emulsions were shaken on a reciprocating shaker at 180 rpm for 24 hrs at different temperatures. Appearance of the emulsions were recorded after shaking and results summarized in Table 16 below.

TABLE 16

| | | Appearance | Appearance | Appearance |
|---|---|---|---|---|
| | Appearance | of Sample | of Sample | of Sample |
| | of Sample | After | After | After |
| | Before | Shaking | Shaking | Shaking |
| Sample | Shaking | at 25° C. | at 4° C. | at −20° C. |
| Example L | Good | Good | Good | Good |
| Example M | Good | Good | Good | Good |
| Example K | Good | Good | Oiling off | Good |

### Examples N-Q

In Examples N-Q, butter emulsions including a flavor were formulated and submitted to a freeze-thaw stability test in which the emulsions were shaken on a reciprocating shaker at 180 rpm for 24 hrs at different temperatures (−4° C. and −20° C.). Appearance of the emulsions were recorded. The ingredients and their respective percentage by weight in Examples N-Q and corresponding test results are shown in below Table 17.

TABLE 17

| | Example N | Example O | Example P | Example Q |
|---|---|---|---|---|
| | wt % of | wt % of | wt % of | wt % of |
| | final | final | final | final |
| Ingredient | emulsion | emulsion | emulsion | emulsion |
| Enzyme-modified | 4.0 | 4.0 | 4.0 | 4.0 |
| butter flavor | | | | |
| Milk flavor | 5.0 | 10.0 | 5.0 | 10.0 |
| Sunflower Oil | 11.0 | 6.0 | / | / |
| Neobee Oil | / | / | 11.0 | 6.0 |
| Vitamin E | 0.02 | 0.02 | 0.02 | 0.02 |
| SY-Glyster | 6.0 | 6.0 | 6.0 | 6.0 |
| MM-750 | | | | |
| Glycerol | 40.0 | 40.0 | 40.0 | 40.0 |
| Water | Q.S. | Q.S. | Q.S. | Q.S. |
| Appearance of | Good | Good | Good | Good |
| sample after | | | | |
| shaking | | | | |
| at 4° C. | | | | |
| Appearance of | Good | Good | Good | Good |
| sample after | | | | |
| shaking | | | | |
| at −20° C. | | | | |

### Examples R-S

In Examples R-S, plant oil emulsions comprising enzyme-modified plant oil were formulated and submitted to a freeze-thaw stability test in which the emulsions were shaken on a reciprocating shaker at 180 rpm for 24 hrs at different temperatures (4° C. and −20° C.). Appearance of the emulsions were recorded. The ingredients and their respective percentage by weight in Examples R-S and corresponding test results are shown in below Table 18.

TABLE 18

| | Example R | Example S |
|---|---|---|
| | wt % of | wt % of |
| Ingredient | final emulsion | final emulsion |
| Enzyme-modified | 4.0 | 4.0 |
| plant oil | | |
| Sunflower Oil | 16.0 | |
| Neobee Oil | | 16.0 |
| Vitamin E | 0.02 | 0.02 |
| SY-Glyster MM-750 | 6.0 | 6.0 |
| Glycerol | 40.0 | 40.0 |
| Water | Q.S. | Q.S. |
| Appearance of sample | Good | Good |
| after shaking at 4° C. | | |
| Appearance of sample | Good | Good |
| after shaking at −20° C. | | |

### Examples T-U

In Examples T-U, plant oil emulsions comprising enzyme-modified plant oil and maltodextrin as thickening agent were formulated and submitted to a freeze-thaw stability test in which the emulsions were shaken on a reciprocating shaker at 180 rpm for 24 hrs at different temperatures (4° C. and −20° C.). Appearance of the emulsions were recorded. The ingredients and their respective percentage by weight in Examples T-U and corresponding test results are shown in below Table 19.

TABLE 19

| | Example T | Example U |
|---|---|---|
| | wt % of | wt % of |
| Ingredient | final emulsion | final emulsion |
| Enzyme-modified | 4.0 | 4.0 |
| plant oil | | |
| Sunflower Oil | 16.0 | / |
| Neobee Oil | / | 16.0 |
| Vitamin E | 0.02 | 0.02 |
| SY-Glyster MM-750 | 6.0 | 6.0 |
| Maltodextrin 18DE | 5.0 | 5.0 |
| Glycerol | 40.0 | 40.0 |
| Water | Q.S. | Q.S. |
| Appearance of sample | Good | Good |
| after shaking at 4° C. | | |
| Appearance of sample | Good | Good |
| after shaking at −20° C. | | |

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, it should be understood that the method steps described herein are exemplary, and upon reading the present disclosure, a skilled person would understand that one or more method steps described herein can be combined, omitted, re-ordered, or substituted.

As used herein, examples of “about” and “approximately” include a specified value or characteristic to within plus or minus 15, 10, 5, 4, 3, 2, or 1% of the specified value or characteristic. As used herein, examples using the term “between” include end points. For example, a range between 1 and 5 include 1 and 5 along with all other values greater than 1 and less than 5.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A lipid or enzyme-modified lipid emulsion, comprising:
an aqueous phase comprising 1.0-15 wt % modified starch or a polyglycerol ester of fatty acids (PGE), relative to the total weight of the emulsion, and 30-50 wt % organic solvent, relative to the total weight of the emulsion; and
an oil phase comprising 1.0-20 wt % lipid or enzyme-modified lipid, relative to the total weight of the emulsion, and 5.0-25 wt % edible oil, relative to the total weight of the emulsion.

2. The lipid or enzyme-modified lipid emulsion of claim 1, wherein the lipid is butter or plant oil.

3. The lipid or enzyme-modified lipid emulsion of claim 1, wherein the enzyme-modified lipid is enzyme-modified butter flavor or enzyme-modified plant oil.

4. The lipid or enzyme-modified lipid emulsion of claim 3, wherein the enzyme-modified butter flavor or enzyme-modified plant oil is selected from the group consisting of monoglyceride, diglyceride, triglyceride, and a mixture thereof.

5. The lipid or enzyme-modified lipid emulsion of claim 1, wherein the lipid or enzyme-modified lipid is present in an amount of less than 20 wt %.

6. The lipid or enzyme-modified lipid emulsion of claim 1, wherein the organic solvent is selected from the group consisting of: glycerol, propylene glycol, ethanol, butanol, sugar alcohol and a mixture thereof.

7. The lipid or enzyme-modified lipid emulsion of claim 1, wherein the organic solvent is present in an amount of greater than 30 wt %.

8. The lipid or enzyme-modified lipid emulsion of claim 1, wherein the edible oil is selected from the group consisting of flavor oil, plant oil, medium-chain fatty acids, medium-chain triglycerides, limonene, glycerin triacetate, ethyl citrate, benzyl benzoate, ethyl laurate, ethyl myristate, and a mixture thereof.

9. The lipid or enzyme-modified lipid emulsion of claim 1, further comprising 0.1-5.0 wt % crystallization inhibitor, relative to the total weight of the lipid or enzyme-modified lipid emulsion, and/or 0-15 wt % weighting agent, relative to the total weight of the lipid or enzyme-modified lipid emulsion.

10. The lipid or enzyme-modified lipid emulsion of claim 9, wherein the crystallization inhibitor is selected from the group consisting of: polyglycerol fatty acid ester, sucrose fatty acid ester, and a mixture thereof.

11. The lipid or enzyme-modified lipid emulsion of claim 9, wherein the weighting agent is selected from the group consisting of: glycerin rosin ester, sucrose acetate isobutyrate, dammar resin, and a mixture thereof.

12. The lipid or enzyme-modified lipid emulsion of claim 1, further comprising: 0.01-2 wt % vitamin E, relative to the total weight of the lipid or enzyme-modified lipid emulsion, and/or 0.01-2.0 wt % vitamin C, relative to the total weight of the lipid or enzyme-modified lipid emulsion.

13. The lipid or enzyme-modified lipid emulsion of claim 1, further comprising: 0.01-2 wt % preservative, relative to the total weight of the lipid or enzyme-modified lipid emulsion.

14. A method for preparing a lipid or enzyme-modified lipid emulsion of claim 1, comprising:
mixing the modified starch or the polyglycerol ester of fatty acids (PGE) with water at a first predetermined temperature to form the aqueous phase;
melting the lipid or enzyme-modified lipid at a second predetermined temperature and mixing the lipid or enzyme-modified lipid with the edible oil at a third predetermined temperature to form the oil phase;
mixing the aqueous phase and the oil phase on a magnetic stirring plate to form the lipid or enzyme-modified lipid emulsion;
pre-emulsifying the lipid or enzyme-modified lipid emulsion using a high-speed homogenizer for a first period of time; and
homogenizing the resulted pre-emulsion at a predetermined pressure for predetermined times using a 2-stage high-pressure homogenizer.

15.-17. (canceled)

18. The method of claim 14, wherein the enzyme-modified lipid is enzyme-modified butter flavor or enzyme-modified plant oil.

19. The method of claim 18, wherein the enzyme-modified butter flavor or enzyme-modified plant oil is selected from the group consisting of: monoglyceride, diglyceride, triglyceride, and a mixture thereof.

20. The method of claim 1, wherein the lipid or enzyme-modified lipid is present in an amount of less than 20 wt %, relative to the total weight of the lipid or enzyme-modified lipid emulsion.

21. (canceled)

22. The method of claim 14, wherein the organic solvent is selected from the group consisting of: glycerol, propylene glycol, ethanol, butanol, sugar alcohol and a mixture thereof.

23. The method of claim 14, wherein the organic solvent is present in an amount of greater than 30 wt %, relative to the total weight of the lipid or enzyme-modified lipid emulsion.

24. The method of claim 14, wherein the edible oil is selected from the group consisting of: flavor oil, plant oil, medium-chain fatty acids, medium-chain triglycerides, limonene, glycerin triacetate, ethyl citrate, benzyl benzoate, ethyl laurate, ethyl myristate, and a mixture thereof.
